(19) United States
(12) Patent Application Publication
(10) Pub. No.: US 2026/0336675 A1
(43) Pub. Date: Oct. 29, 2026

(54) SYSTEM AND METHOD FOR MANAGING PANTOGRAPH ARRANGEMENTS ON RAIL VEHICLES

(71) Applicant: HACK PARTNERS LIMITED, Devizes (GB)

(72) Inventors: Haydon BARTLETT-TASKER, Tonbridge (GB); Shayan TAHERIAN, London (GB); Kirill GARBAR, Aylesbury (GB)

(73) Assignee: HACK PARTNERS LIMITED, Devizes (GB)

(21) Appl. No.: 19/114,252

(22) PCT Filed: Sep. 22, 2023
(86) PCT No.: PCT/IB2023/059389

§ 371 Date: Mar. 21, 2025

(30) Foreign Application Priority Data
Sep. 22, 2022 (GB) 2213851.5

(51) Int. Cl. B61L 27/53; B61C 3/00; B61L 23/00; B61L 25/02; G06T 7/00; G06V 20/54; G07C 5/00; G07C 5/08

(52) U.S. Cl. CPC B61L 27/53; B61C 3/00; B61L 23/00; B61L 25/025; G06T 7/0002; G06V 20/54; G07C 5/008; G07C 5/0825; G06T 2200/24; G06T 2207/30236

(57) ABSTRACT

A system for managing pantograph arrangements includes at least one camera that captures images, being arranged in a railway environment such that pantograph arrangement of at least one rail vehicle would lie in its field of view, and wherein the pantograph arrangement includes a pantograph and a pantograph well; and at least one processor communicably coupled to at least one camera, being configured to receive images from at least one camera; process images to detect whether at least one of: damage to pantograph arrangement, presence of foreign object in or around pantograph arrangement, is indicated in at least one image amongst images; and perform at least one action when it is detected that at least one of: damage to pantograph arrangement, presence of foreign object in or around pantograph arrangement, is indicated in at least one image.

### TECHNICAL FIELD

The aspects of the disclosed embodiments relate to monitoring and maintaining pantograph arrangements. In particular, though not exclusively, the disclosed embodiments relate to a system for monitoring and maintaining pantograph arrangements on rail vehicles and a method for managing pantograph arrangements on rail vehicles. By “management” is meant “monitoring and maintaining”; such monitoring includes a use of sensors.

### BACKGROUND

With advances in technology, electric trains have been incorporated in transportation systems throughout the globe. Such trains often utilise pantographs and/or other similar apparatus to harness electric current from overhead lines for powering the trains. Pantographs are critical assets ensuring operational working of railways. Railways face reduced reliability and catastrophic incidents when the pantographs are damaged by objects, resulting in transportation system failures. Typically, such failures are infrastructure-borne, wherein the overhead lines or other railway infrastructure strikes a given pantograph causing chips, cracks or completely destroying the given pantograph. In other cases, such failures are train-borne, wherein foreign objects or debris get caught in the given pantograph and/or a well of the given pantograph, thereby damaging the overhead lines and/or the given pantograph. In such cases, significant disruptions are caused which not only affect passengers but cost millions of dollars in lost economic output and for infrastructure repairs.

Due to this, objects which may cause damage to the pantograph or rail infrastructure must be identified in a timely manner before the damage occurs, so that operators are able to take action to avoid an incident arising. However, existing systems are not sufficiently well developed to identify the damage to the pantograph or to its particular parts accurately. One potential possible reason for this is that the existing solutions do not monitor the pantograph well surrounding the pantograph. The pantograph well is present in close proximity to the pantograph, and is an area where foreign objects may lie and cause or be likely to cause dangerous incidents. Without proper monitoring of the pantograph well, several identifiable issues or faults in pantograph arrangements of rail vehicles remain undetected until they actually begin to cause damage to life and property.

Therefore, in light of the foregoing discussion, there exists a need to overcome the aforementioned drawbacks associated with managing pantograph arrangements on rail vehicles.

### SUMMARY OF THE DISCLOSED EMBODIMENTS

A first aspect of the disclosed embodiments provides a system for managing at least one pantograph arrangement on at least one rail vehicle, wherein the at least one pantograph arrangement includes a corresponding pantograph and a pantograph well, wherein the system comprises:
at least one camera that is configured, when in operation, to capture one or more images of a railway environment in which at least one rail vehicle operates, wherein the at least one camera is arranged in the railway environment such that at least one pantograph arrangement of the at least one rail vehicle would lie in its field of view;
at least one processor communicably coupled to the at least one camera, wherein the at least one processor is configured to:
   receive the one or more images from the at least one camera;
   process the one or more images to detect therein whether or not at least one of: a damage to the pantograph arrangement, a presence of a foreign object in or around the pantograph arrangement, is indicated in one or more images; and
   perform at least one action when it is detected that at least one of: the damage to the pantograph arrangement, a presence of the foreign object in or around the pantograph arrangement, is indicated in the one or more images.

The system for managing pantograph arrangements on rail vehicles, in operation, beneficially detects an indication of at least one of: the damage to the pantograph arrangement, the presence of the foreign object in or around the pantograph arrangement, in the one or more images. This means that the system described herein monitors for a wide range of identifiable issues or faults in pantograph arrangements of rail vehicles, so as to enable timely detection and correction of such issues. By monitoring pantograph wells in addition to the pantographs, the system detects several additional issues or potential issues, when compared with existing known solutions. The system also performs at least one action if such indication is detected; in other words, the at least one action beneficially includes a maintenance action. It will be appreciated that the system is configurable to detect a comprehensive variety of actual and potential issues in the pantograph arrangement, which is beneficially time-effective, improves safety and reliability of the pantograph arrangement, and is also cost-effective and easy to implement.

Throughout the present disclosure, the term “pantograph arrangement” refers to an arrangement of apparatus mounted on a roof of the at least one rail vehicle, to collect power through contact with an overhead line, and a surrounding region of the arrangement of apparatus. It will be appreciated that the pantograph arrangement acts as a current collector arrangement, as it collects current from the overhead line for powering the at least one rail vehicle. Examples of the pantograph arrangement include, but are not limited to, a single arm pantograph arrangement, a double arm pantograph arrangement. In some embodiments, one pantograph arrangement is installed onto a given rail vehicle. In other embodiments, multiple pantographs are installed onto a single pantograph arrangement of a given rail vehicle. In such embodiments, the multiple pantographs may be installed in opposite directions in order to enable efficient current collection when the rail vehicle is running in either of a reverse direction or a forward direction.

The pantograph arrangement comprises a pantograph and a pantograph well. The pantograph is a mechanical device which extends from the roof of the at least one rail vehicle and is configured to make contact with the overhead line, to collect current from the overhead line. Optionally, the pantograph comprises at least: a lower arm, an upper arm, a balance rod, a collector head and a spring. The lower arm, the upper arm and the balance rod form an arm assembly to which the collector head is connected at a top portion of the arm assembly. The collector head is optionally implemented as a carbon strip collector head, a metal strip collector head, or any other suitable collector head. Moreover, the spring is connected to a bottom portion of the arm assembly to enable easy movement of the arm assembly. It will be appreciated that the arm assembly may be moved to vary the height of the pantograph. Since overhead lines may be at varying heights, varying the height of the pantograph is beneficial for collecting the current.

The pantograph well refers to an area (i.e., a designated space or compartment) on the roof of the at least one rail vehicle, said area surrounding the pantograph. The pantograph well is a flat, an elevated, or a recessed enclosed area on the roof of the at least one rail vehicle designed to house and protect the pantograph. The pantograph well also contributes to an aerodynamic and aesthetic profile of the at least one rail vehicle. Optionally, the pantograph well comprises a base frame, at least one insulator, and a compressed air assembly. Optionally, the pantograph well is defined by the base frame. It will be appreciated that the compressed air assembly is utilised for varying a height of the pantograph relative to ground height. Herein, compressed air is provided at a lower portion of the upper arm and the collector head, which pushes the arm assembly (and, hence, the pantograph) upwards. When the compressed air is not provided, the arm assembly returns to its resting position.

A technical advantage of capturing images of the pantograph and the pantograph well is that foreign objects in the pantograph well may be timely identified and removed in addition to damage of the pantograph may be monitored. It will be appreciated that several dangerous or potentially dangerous conditions cannot be detected by monitoring of the pantograph alone or by monitoring of any part of the pantograph alone. As an example, when the foreign objects (such as vegetation, clothing, birds, and the like) are present in the pantograph well, they may become entangled with the overhead lines when the at least one rail vehicle moves, and this may potentially cause serious damage and dangerous conditions such as failure of the overhead lines, dewirements such as falling or snapping of the overhead lines (which may potentially lead to electrocution, severed limbs and death of people or animals if it happened in their vicinity). Detection of such foreign objects is not possible without monitoring the pantograph well. As another example, when the foreign objects become caught in the overhead lines which snag on other infrastructure items, it may cause the pantograph or the whole pantograph arrangement to be ripped off the roof of the at least one rail vehicle. This has been known to happen in reality, where upon getting ripped off, the pantograph went through a window of a carriage of the at least one rail vehicle, into an interior region of the carriage. Such a dangerous condition with possible risk to life and serious damage to the at least one rail vehicle, is not detectible without monitoring the pantograph well. As yet another example, when the foreign objects present or stuck in the pantograph well of a moving rail vehicle fly away or become loose, they leave the rail vehicle at a very high speed like a missile or projectile. Such foreign objects pose a risk to life and are detectible only upon monitoring of the pantograph well. As still another example, a presence of damaged or missing parts in the pantograph arrangement, such as missing bolts, damaged insulators, damaged chains, and the like, may potentially cause serious damage to life and property. Missing bolts lead to pantograph instability, reduced contact with the overhead wires, or even a risk of the pantograph falling off or malfunctioning. Damaged insulators pose a risk of electrical short circuits or other electrical problems within the pantograph, which may potentially lead to safety concerns and electrical system failures. Damage to chains (which maintain alignment of carbon strips with overhead lines) may potentially cause misalignment, reduced contact with the overhead lines, potential electrical disconnections, and may also potentially also put additional stress on other parts of the pantograph. Such dangerous conditions are detectable by monitoring the pantograph well. Therefore, the pantograph arrangement as a whole (meaning both the pantograph and the pantograph well) is effectively managed by monitoring it for such as damages and/or presence of foreign objects in or around it, and upon detection of such dangerous or potentially dangerous conditions, performing the at least one action.

Throughout the present disclosure, the term “rail vehicle” refers to a vehicle which is utilised for transporting people or cargo on a rail transport system. Examples of the at least one rail vehicle include, but are not limited to, a railroad car, a railcar, a railway wagon, a railway carriage, a railway truck, a rail wagon, a rail carriage, a rail truck, a train car, a train wagon, a train carriage, a train truck. Optionally, the at least one rail vehicle is implemented as at least one of: a train, a tram, an electric bus. Optionally, the at least one rail vehicle is an electric rail vehicle. It will be appreciated that electric rail vehicles are operated using electricity, and thereby utilise the pantograph arrangement.

Throughout the present disclosure, the term “camera” refers to an optical instrument which captures images of the railway environment. It will be appreciated that the at least one camera is arranged such that the pantograph arrangement of the at least one rail vehicle lies in its field of view. The term “field of view” of the at least one camera refers to an observable extent of the railway environment that is captured by the at least one camera, whether statically or my periodically using the camera to scan the railway environment. The field of view of the at least one camera is expressed in terms of degrees or radians. The field of view of the at least one camera may depend on the size of the at least one camera, a zoom capability of camera lens of the at least one camera, and similar. Optionally, the field of view of the at least one camera is greater than 100 degrees. As an example, the field of view of the at least one camera may be 100, 110, 120, 130, 140, 150, 160, 170, 180, 190, 200, 210, 220 degrees, and so forth.

The railway environment is an environment of railway transportation infrastructure. The railway environment includes, but is not limited to, at least one train, at least one train track, at least one railway station. The railway environment potentially also includes at least one of vegetation, natural structures, man-made structures (such as bridges, electrical systems, and the like). It will be appreciated that the at least one rail vehicle operates in the railway environment. Notably, the at least one camera is arranged in the railway environment since the pantograph arrangement is a part of the railway environment.

Optionally, the at least one camera is arranged at a height on at least one object, wherein the at least one object is present at one or more of: along a side of a railway track on which the at least one rail vehicle operates, across the railway track on which the at least one rail vehicle operates, between two adjacent pairs of railway tracks. Optionally, the at least one object is part of at least one of: a railway infrastructure, a non-railway infrastructure. Herein, the at least one object may, for example, be a signal pole, which may be part of the railway infrastructure. Alternatively, the at least one object may be an electricity pole, which may be part of the normal infrastructure. The term “non-railway infrastructure” refers to any infrastructure that is not part of the railway infrastructure. Optionally, the at least one object is at least one of: a bridge, a building, a tree, a pole, a signal, a signboard, a component of electricity distribution network, and the like. In an example, the at least one object is a pole. Notably, the at least one camera captures the images at a given location. Herein, the given location is a location of the at least one camera (i.e., a location of the at least one object), since the at least one camera is stationary. The given location lies within or in proximity of the railway environment that is to be imaged.

When the at least one object is present along sides of the railway track on which the at least one rail vehicle operates, the at least one camera captures the side perspective view of the pantograph arrangement since the object would be present on either side of the at least one rail vehicle when the at least one rail vehicle crosses the at least one object. When the at least one object is present across the railway track on which the at least one rail vehicle operates, the at least one camera captures the top perspective view of the pantograph arrangement since the object would be present on top of the at least one rail vehicle when the at least one rail vehicle crosses the at least one object. Moreover, when the at least one object is present between two adjacent pairs of railway tracks, the at least one camera captures the side perspective view of the pantograph arrangement since the object would be present on a side of the at least one rail vehicle when the at least one rail vehicle crosses the at least one object. A technical advantage of arranging the at least one object in the above-mentioned manner is that it can accurately capture the pantograph arrangement from multiple locations and view different perspectives of the pantograph arrangement.

Optionally, the at least one camera is arranged to capture at least one of: a top perspective view, a side perspective view, of the pantograph arrangement of the at least one rail vehicle. The top perspective view shows the pantograph arrangement of the at least one rail vehicle from the top and the side perspective view shows the pantograph arrangement of the at least one rail vehicle from the side. It will be appreciated that the top perspective view and the side perspective view accurately show the damage to the pantograph arrangement and/or the presence of the foreign object in or around the pantograph arrangement, if the same exists. Since the at least one camera is placed at the height on the at least one object, it captures a perspective view of the pantograph arrangement. The perspective view is a two-dimensional representation of a three-dimensional space (i.e., the railway environment) where an apparent size of the at least one rail vehicle decreases as its distance from the at least one camera increases, unless the at least one camera employs a zoom camera lens. A technical advantage of this is that such placement provides a beneficial angle for feature extraction of the pantograph arrangement, in the at least one image. In particular, such perspective views enable imaging of various portions of the pantograph arrangement (such as the pantograph and the pantograph well), thereby enabling more accurate detection of damages and/or presence of foreign objects as compared to existing solutions which capture perspective views representing only pantographs or parts thereof.

In some embodiments, the at least one camera captures a top perspective view of the pantograph arrangement of the at least one rail vehicle. In other embodiments, the at least one camera is implemented as a first camera which captures a top perspective view of the pantograph arrangement of the at least one rail vehicle, and a second camera which captures a side perspective view of the pantograph arrangement of the at least one rail vehicle. In other embodiments, there may be multiple cameras arrangements in many locations along a railway track. The multiple cameras may be arranged to capture different perspectives of the pantograph arrangement.

Optionally, at least one processor controls the at least one camera to capture a plurality of images of the railway environment, wherein at least one image from amongst the plurality of images represents a zoomed-in view of at least one portion of the pantograph arrangement. The zoomed-in view may be captured by way of optical zoom or digital zoom. The zoomed-in view is beneficially very useful in improving an accuracy of detection of the damage to the pantograph arrangement and/or presence of the foreign object in or around the pantograph arrangement. Optionally, the at least one portion of the pantograph arrangement whose zoomed-in view is to be captured, is selected based on historically-detected damages to the pantograph arrangements and/or historically-detected foreign objects in or around the pantograph arrangement.

Throughout the present disclosure, the term “processor” refers to a hardware, software, firmware, or a combination of these configured to control operation of the system. In this regard, the at least one processor performs several complex processing tasks. The at least one processor is communicably coupled to other components of the system wirelessly and/or in a wired manner. In an example, the at least one processor may be implemented as a programmable digital signal processor (DSP). In another example, the at least one processor may be implemented as a cloud server that provides a cloud computing service. Optionally, the at least one processor is communicably coupled to the at least one camera using a communication network. The communication network may be a wired network, a wireless network, or any combination thereof. Examples of the communication network include, but are not limited to, Local Area Networks (LANs), Wide Area Networks (WANs), Internet, radio networks and telecommunication networks.

Notably, the at least one processor receives the images through a communication network. The images are transferred in real time or near-real time from the at least one camera to the at least one processor, so as to enable swift monitoring and action performance in respect of the pantograph arrangement. Beneficially, once received, the at least one processor processes the images to timely identify at least one of: the damage to the pantograph arrangement, the presence of the foreign object in or around the pantograph arrangement, and subsequently performs the at least one action for remedying the same. Furthermore, at least some of the images may be stored at a data repository of the system, wherein the at least one processor is communicably coupled with the data repository. In this regard, the system further comprises the data repository. For example, at least the images indicative of the at least one of: the damage to the pantograph arrangement, the presence of the foreign object in or around the pantograph arrangement, may be stored for future use.

It will be appreciated that the pantograph arrangement may not be clearly visible in all of the images captured by the at least one camera. This may be because the at least one camera is installed on the object and the at least one rail vehicle is often in motion, such that the pantograph arrangement is clearly visible in at least a few images from amongst a plurality of images that are captured when the at least one rail vehicle passes the at least one camera. Moreover, it will be appreciated that the at least one image is indicative of the damage to the pantograph arrangement and/or the presence of the foreign object in or around the pantograph arrangement. Optionally, blurry images amongst the plurality of images that are captured are discarded (i.e., are not processed). Alternatively, the blurry images are processed using an inverse convolution algorithm executed on the at least one processor. Optionally, the inverse convolution algorithm is configured to remove effects of defocussing and/or vibration. Optionally, the inverse convolution algorithm uses a subtraction of an overlay of multiple images to implement such correction.

The phrase “damage to the pantograph arrangement” encompasses chips, cracks or general wear-and-tear of the pantograph arrangement which renders the pantograph arrangement potentially structurally impaired or weak, and/or which reduces the efficacy of the pantograph arrangement. The damage to the pantograph arrangement may in some instances be severe and lead to service disruptions or risk to people. Examples of the damage to the pantograph arrangement include, but are not limited to, a worn collector head, a chip in the pantograph arrangement, a crack in the pantograph arrangement, inaccurate functioning of the arm assembly, inaccurate functioning of the compressed air assembly, misalignment of the pantograph system. Optionally, the damage to the pantograph system is caused by at least one of: the overhead lines, the railway infrastructure, the non-railway infrastructure, the foreign object, striking the pantograph arrangement; exposure to environmental factors like moisture and pollution; exposure to corrosive chemicals; electrical arcing between the overhead line and the pantograph, mechanical failures. As an example, the striking of the overhead lines and/or the railway infrastructure is one of the most common causes of the damages to the pantograph arrangement.

The term “foreign object” refers to an object which is foreign to the pantograph arrangement (i.e., which is not a part of the pantograph arrangement). It will be appreciated that when any object which does not belong in or around the pantograph arrangement is detected therein, it may be deemed as the foreign object. Examples of the foreign object include, but are not limited to, an animal, vegetation (for example, tree branches), apparel (for example, t-shirts), accessories, luggage, stationary, electric components, containers, wires, mechanical parts, water, and a piece of overhead line equipment. Notably, such foreign objects often get caught within the pantograph arrangement and continue residing therein, causing damage to the overhead lines and/or the pantograph arrangement. Moreover, such foreign objects often lie in the pantograph well, and would be undetected if the pantograph well were not imaged for analysis. Even if such foreign objects lie around the pantograph arrangement (for example, lie on a portion of the roof of the at least one rail adjacent to the pantograph well), there is a likelihood of them undesirably interfering with the pantograph arrangement and/or the overhead line, due to motion of the train, action of wind, and the like.

Notably, the images are processed by the at least one processor to detect the damage to the pantograph arrangement and/or the presence of the foreign object in or around the pantograph arrangement. Optionally, prior to processing, the images are pre-processed using at least one image processing algorithm. In this regard, the at least one image processing algorithm may be at least one of: an image de-blurring algorithm, an image sharpening algorithm, a contrast adjustment algorithm, an image cropping algorithm, an image lighting adjustment algorithm, and the like.

Optionally, when processing the images, the at least one processor employs at least one computer vision algorithm. The term “computer vision algorithm” refers to an algorithm which enables a computer to recognise objects and/or irregularities when processing the images. Herein, the at least one computer vision algorithm is utilised to detect the damage to the pantograph arrangement and/or the presence of the foreign object in or around the pantograph arrangement. It will be appreciated that the at least one computer vision algorithm utilises at least one of: feature recognition, feature matching, object detection, object classification, pattern recognition, image processing, and similar techniques to detect any abnormal variation (i.e., damage and/or the presence of the foreign object) in the pantograph arrangement. Examples of the at least one computer vision algorithm include, but are not limited to, a scale-invariant feature transform (SIFT) algorithm, a speeded up robust features (SURF) algorithm, a Viola-Jones object detection algorithm, a Lucas-Kanade optical flow algorithm, a Kalman filter algorithm, a mean shift algorithm, an adaptive thresholding algorithm, a graph cut algorithm, a “you only look once” (YOLO) algorithm. Beneficially, the at least one computer vision algorithm accurately processes the images, reducing false-positive results. Moreover, the at least one computer vision algorithm is time-effective since it appropriately utilises processing capabilities of the at least one processor, which assists in timely remedying the damage to the pantograph arrangement and/or the presence of the foreign object in or around the pantograph arrangement.

Optionally, when processing the images, the at least one processor uses a neural network, wherein the processor is configured to:
provide, as an input to the neural network, the images of the railway environment in which at least one rail vehicle operates; receive, as an output from the neural network, reference images which are similar to the images, wherein a given reference image represents a similar perspective of the railway environment as its corresponding image and includes an ideal representation of the pantograph arrangement. Optionally, in this regard, the at least one computer vision algorithm is used to detect, for each image amongst the (captured) images, differences between features identified in said image and features identified in its corresponding reference image. Detection of the differences for the at least one of the images means that the at least one of: damage to the pantograph arrangement, a presence of the foreign object in or around the pantograph arrangement, is detected. Notably, a position of the pantograph arrangement in the given reference image, is similar to a position of the pantograph arrangement in its corresponding (captured) image. The neural network is, for example, an artificial neural network. It will be appreciated that with this approach, a dataset of reference images that includes representations of un-damaged and foreign object-free pantograph arrangements is utilized for detecting damage and/or presence of the foreign object. This enables accurate detections of such dangerous and/or potentially dangerous conditions, and timely performance of requisite action(s). Optionally, the neural network may be implemented as a Boltzmann machine, a Born machine or similar

It will be appreciated that timely detecting the damage to the pantograph arrangement and/or the presence of the foreign object in or around the pantograph arrangement is critically beneficial since an underlying issue may be fixed in a timely manner to avoid incurring losses of property and life. Such detection is beneficially performed with respect to both the pantograph and the pantograph well, thereby achieving monitoring of a considerably large number of actual and potential dangerous conditions associated with the pantograph arrangement on the at least one rail vehicle.

The at least one action refers to an act which assists in at least one of: ultimately remedying the damage to the pantograph arrangement, removing the foreign object that is present in or around the pantograph arrangement, avoiding damage to the pantograph arrangement, avoiding damage to the overhead line. Optionally, the at least one action is determined based at least on: a type of damage to the pantograph arrangement, an extent of damage to the pantograph arrangement, a type of the foreign object the present in or around the pantograph arrangement, a position and/or an orientation of the foreign object with respect to the pantograph arrangement, the location of the at least one rail vehicle at a time of capturing the images indicative of the damage and/or the presence of the foreign object, a current location of the at least one rail vehicle. Notably, when the at least one of: the damage to the pantograph arrangement, the presence of the foreign object in or around the pantograph arrangement, is not detected upon processing the at least one image, no action is performed by the at least one controller. Beneficially, when the damage to the pantograph arrangement and/or the presence of the foreign object in or around the pantograph arrangement is not detected, it means that the pantograph arrangement is functioning properly and that there is no underlying issue or potential issue to remedy or avoid.

Optionally, the at least one processor is further configured to determine the at least one action that is to be performed, wherein the at least one action is determined by at least one of:
identifying an action from amongst a look up table including actions corresponding to damages to pantograph arrangements and/or foreign objects that are present in or around the pantograph arrangements, by matching currently-detected damage and/or foreign object with the damages and/or the foreign objects in the look up table;
predicting an action using a machine learning model that is pre-trained to learn actions corresponding to damages to pantograph arrangements and/or foreign objects that are present in or around the pantograph arrangements;
searching a database of historically-performed actions for historically-detected damages to pantograph arrangements and/or historically-detected foreign objects in or around the pantograph arrangements.

Optionally, performing the at least one action comprises:
generating an alert indicative of at least the damage to the pantograph arrangement and/or the presence of the foreign object in or around the pantograph arrangement; and
sending the alert to a device associated with an entity that manages the pantograph arrangements on the rail vehicles.

In operation, the alert is provided at the device as soon as the damage to the pantograph arrangement and/or the presence of the foreign object in or around the pantograph arrangement is detected. The term “alert” as used herein refers to a form of signal or message that is conveyed to the entity that manages the pantograph arrangements on the rail vehicles, that damage to the pantograph arrangement and/or the presence of the foreign object in or around the pantograph arrangement has been detected. Herein, the alert is targeted to the entity such that the entity may rectify the damage to the pantograph arrangement and/or remove the foreign object from/around the pantograph arrangement, and thus may effectively correct present issues and/or avoid any further issues with respect to the pantograph arrangement. A technical advantage of this is that the entity can then timely fix detected damages or remove potentially dangerous foreign objects before a major fault occurs (i.e., prevent further damages and/or faults). The entity could be a person, a group of people, an organization, or similar, that is/are responsible for managing pantograph arrangements for maintaining safe operation of the at least one rail vehicle or, optionally, the normal operational working of the railway.

Optionally, the at least one processor is further configured to determine a corrective action to be performed for remedying the damage to the pantograph arrangement and/or the presence of the foreign object in or around the pantograph arrangement, and wherein the alert is also indicative of the corrective action. Throughout the present disclosure, the term “corrective action” refers to a physical action which is performed for remedying the damage to the pantograph arrangement and/or the presence of the foreign object in or around the pantograph arrangement, and wherein the alert is also indicative of the corrective action. An may potentially implement the corrective action itself or by using services of a third party. Examples of the corrective action include, but are not limited to, removing the foreign object from the pantograph arrangement or its surroundings, repairing the damage to the pantograph arrangement (for example, by repairing faulty parts, by replacing faulty parts, by adding new parts, or similar), servicing the pantograph arrangement, taking the damaged pantograph arrangement out of service and running the rail vehicle on another pantograph arrangement. It will be appreciated that the alert indicative of the corrective action accurately instructs the entity in remedying issues with respect to the pantograph arrangement. This alert and acting thereupon, beneficially, saves time and effort of the entity in deciding the corrective measure manually.

Notably, the alert is also indicative of the corrective action. In an example, if a shoe is detected in a pantograph well of train number 245067, running from King's Cross to Cambridge, an alert generated with respect to this may indicate a corrective action of removing the shoe. Optionally, a set of corrective actions for remedying issues (i.e., damage to the pantograph arrangement and/or foreign objects' presence in or around the pantograph arrangement) with respect to the pantograph arrangement are pre-determined. In this regard, the set of corrective actions may be stored at the data repository associated with the at least one processor. Moreover, each corrective action from the set of corrective actions may be pre-determined for remedying a given issue with respect to the pantograph arrangement based on at least one of: pre-existing domain knowledge pertaining to correction of the given issue, historical corrective action(s) performed for successfully correcting the given issue, newly-proposed corrective action(s) that are likely to successfully correct the given issue. Herein, the at least one processor may be configured to determine the corrective action to be performed for remedying the given issue by at least one of: performing a lookup operation within the data repository based on the currently-detected issue, employing a pre-trained machine learning model to select the corrective action from amongst the set of corrective actions. Beneficially, the corrective action being indicated in the alert enables the entity to timely remedy the damage to the pantograph arrangement and/or the presence of the foreign object in or around the pantograph arrangement.

Optionally, the alert also comprises at least one of: a location of the at least one rail vehicle at a time of capturing the at least one image, the at least one image depicting the damage to the pantograph arrangement and/or the presence of the foreign object in or around the pantograph arrangement. It will be appreciated that the location of the at least one rail vehicle at the time of capturing the at least one image is determined based on a location of the at least one camera that captured the at least one image or optionally, based on a location sensor arranged in the at least one rail vehicle wherein the location sensor is communicably coupled with the at least one processor. Moreover, the location of the at least one camera depends on a location of the at least one object onto which the at least one camera is installed. For example, the alert may read: “Attention! A potential pantograph debris has been detected on the pantograph of the 700 train that has just passed Platform 1 in East Croydon”. Moreover, the at least one image may be provided to the entity in the alert for purpose of obtaining confirmation of the detection of the damage and/or the presence of the foreign object. The entity may be able to analyse and assess the at least one image to confirm or deny the detection of the damage and/or the presence of the foreign object. It will be appreciated that the location assists in determining an accurate location of the at least one rail vehicle at the time for efficiently remedying the damage to the pantograph arrangement and/or the presence of a foreign object in or around the pantograph arrangement or the location of damaged infrastructure (for example a broken registration arm of the Overhead Line System). Beneficially, the at least one image being provided in the alert allows the entity to manually confirm the damage and/or the presence of a foreign object.

Optionally, the at least one image is captured by a thermal camera that is configured to detect temperature hot-spots that are indicative of one or more local failures within a given pantograph.

Furthermore, optionally, the at least one processor is configured to: receive sensor data indicative of a velocity of the at least one rail vehicle from at least one sensor arranged within the vehicle; and
determine at least one of: a current location of the at least one rail vehicle at a time of generation of the alert, a future location of the at least one rail vehicle at a future time instant, based on the location of the at least one rail vehicle at the time of capturing the at least one image and the velocity of the at least one rail vehicle. Optionally, the alert also comprises at least one of: the current location, the future location and the future time instant.

In this regard, the at least one sensor comprises at least one of an inertial measurement unit, a Global Positioning System receiver, a wheel rotation sensor, and the like. Up-to-date and/or predicted location tracking of the at least one rail vehicle beneficially enables the system to effectively assist the entity in implementation of the corrective action according to movement of the at least one rail vehicle.

Optionally, the at least one processor is further configured to receive, from the device, a response from the entity with respect to the alert, wherein the response is indicative of one of: accurate detection of the damage and/or the presence of the foreign object, inaccurate detection of the damage and/or the presence of the foreign object. The response is provided to the at least one processor of the system via the device. Optionally, the response is provided in at least one of: a written manner, a haptic manner, selection of an option from multiple given options, an oral (“verbal”) manner, a gestural manner. For example, two call-to-action buttons may be provided in the alert, of which, the entity may choose “accurate detection of the damage and/or the presence of the foreign object” from amongst two options “accurate detection of the damage and/or the presence of the foreign object” and “inaccurate detection of the damage and/or the presence of the foreign object”.

Herein, when the response is of the accurate detection of the damage and/or the presence of the foreign object, it indicates that the detection by the at least one processor is correct, and that the entity will be performing the corrective action. However, when the response is of inaccurate detection, it indicates that the detection by the at least one processor is incorrect, and that the at least one computer vision algorithm employed by the at least one processor is inaccurate and needs to be improved. The requisite improvement in such cases may be made based on further inputs received from the entity, such inputs being received in response to inaccuracy-related queries sent from the at least one processor to the device associated with the entity. A technical advantage of this is that the response provides feedback for the at least one processor with respect to accuracy of the detection, which either reinforces/validates such detection or in case of inaccuracy, eventually further enables improvement of the accuracy of such detection. This is because the response either indicates that the damage and/or the presence of the foreign object will be remedied, or improves the at least one computer vision algorithm for detecting the damage and/or the presence of the foreign object in or around the pantograph arrangement.

Optionally, the at least one processor is further configured to:
generate statistical information based on at least one of: the damage to the pantograph arrangement, the presence of the foreign object in or around the pantograph arrangement, the at least one image; and
represent, via an interactive user interface, at least one of: the statistical information, a report generated based on the statistical information.

The term “statistical information” refers to information which provides statistical insights regarding various aspects of management of the pantograph arrangement. Examples of constituents of the statistical information include, but are not limited to, a time at which the alarm was generated, an entity for whom the alarm was generated, a number of rail vehicles analysed in a duration of time, a number of alerts raised, a number of pantograph arrangements analysed, a number of foreign objects detected, a number of damaged pantograph arrangements detected, a number of damages detected in the pantograph arrangements, identification information of one or more rail vehicles in which damage to the pantograph arrangement and/or presence of a foreign object in or around the pantograph arrangement is detected. Optionally, the statistical information is represented in a form of at least one of: data values, a representation of data values. Examples of the representation of data values include, but are not limited to, a histogram, a pie chart, a line diagram, and a heat map. For example, the statistical information pertaining to the number of pantograph arrangements analysed in one day may be represented as a number (i.e., the data value), and the statistical information pertaining to a number of pantograph arrangements analysed per day over multiple days (i.e., the representation of data values) may be represented as a bar graph or a line diagram.

The term “interactive user interface” refers to an interface via which the entity can interact with the system. Optionally, the interactive user interface is displayed on the device associated with the entity. It will be appreciated that at least one of: the statistical information, the report generated based on the statistical information are represented to the entity via the interactive user interface. The term “report” refers to a summary and/or an analysis of the statistical information. The report may be represented in at least one of: a text form, a graphical form, a combination of the text form and the graphical form. Optionally, in this regard, the at least one processor is configured to generate the report, based on the statistical information. Optionally, in this regard, the at least one processor is configured to use at least one large language model for generating the report based on the statistical information. Automatic report generation enables efficient overview of damage to and/or foreign objects in or around the pantograph arrangement, by the entity. Optionally, the report is represented to the entity, on the device associated with the entity. Beneficially, the statistical information and the report provides in-depth insight into monitored data and issues pertaining to pantograph arrangements present in the railway environment.

Optionally, processing data stored at the data repository further includes data pertaining to whether at least one of: the damage to the pantograph arrangement, the presence of the foreign object in or around the pantograph arrangement, is indicated in the at least one image amongst the images. Moreover, data stored at the data repository further includes the at least one image, the location of the at least one camera, the location of the at least one rail vehicle, the alert, the statistical information, and the report.

Optionally, the at least one processor is further configured to:
receive a sequence of surveillance images of the railway environment in which at least one rail vehicle operates, from the at least one camera or from at least one additional camera which is also arranged in the railway environment such that the pantograph arrangement of the at least one rail vehicle would lie in its field of view;
process the surveillance images according to the sequence in which they are received, to detect when a rail vehicle is present in the railway environment;
when it is detected that the rail vehicle is present in the railway environment, trigger the processing of the images received from the at least one camera, to detect whether at least one of: the damage to the pantograph arrangement, presence of the foreign object in or around the pantograph arrangement, is indicated in the at least one of the images. In this regard, the system implements a triggering mechanism for detection of existing and/or potential issues with the pantograph arrangements on the rail vehicles. Optionally, the images captured by the at least one camera comprise the sequence of surveillance images. This means that no additional camera is used for surveillance, and triggering of image processing occurs based on detection of the rail vehicle upon processing of a video feed received from the at least one camera. Alternatively, optionally, the sequence of surveillance images is captured by the at least one additional camera, and triggering of processing of the images captured by the at least one camera occurs based on detection of the rail vehicle upon processing of a video feed received from the at least one additional camera. Optionally, the rail vehicle is detected to be present in the railway environment when a portion of the rail vehicle is detected to lie within a bounding box around at least one railway track in the railway environment. For example, when a portion of an engine of the rail vehicle is detected to lie within the bounding box, the rail vehicle is detected to be present in the railway environment. Dimensions of the bounding box can be pre-defined prior to using the system.

Optionally, a plurality of systems for managing pantograph arrangements on rail vehicles are deployed in a geographical area, to create a distributed network of inspection systems across a rail network in the geographical area. Optionally, in this regard, the plurality of systems for managing pantograph arrangements on rail vehicles, are communicably coupled with each other. Furthermore, operational steps that are to be performed by processors of the plurality of systems can be implemented by at least one central server for the distributed network. For example, 20 systems for managing pantograph arrangements on rail vehicles may be deployed at different locations in the geographical area, thereby creating 20 monitoring sectors on the rail network. Upon receiving of the alert at the device associated with the entity that manages the pantograph arrangements on the rail vehicles, it can be accurately pinpointed as to which sector of the rail network is affected. For example, a sector where overhead line infrastructure damage may be causing pantograph damage, or a second where foreign debris may be present in the pantograph or the pantograph well, can be accurately determined in this way and (corrective and/or preventive) action(s) can be performed accurately.

Optionally, the system for managing pantograph arrangements on rail vehicles is used in conjunction with a system for automated inspection of the railway environment. In this regard, the system for automated inspection of the railway environment detects existing and/or potential hazards through analysis of video feeds captured by forward-facing cameras on rail vehicles. When the system for managing pantograph arrangements on rail vehicles detects that at least one of: the damage to the pantograph arrangement, presence of the foreign object in or around the pantograph arrangement, is indicated in the at least one image, the system for automated inspection of the railway environment may be used to provide exact information on what is causing the at least one of: the damage to the pantograph arrangement, presence of the foreign object in or around the pantograph arrangement. For example, if it is detected by the system for managing pantograph arrangements on rail vehicles that an Overhead Line Equipment (OLE) registration arm of the pantograph arrangement is broken, a tree or another asset, for example, which has caused this breakage may be determined by the system for automated inspection of the railway environment.

A second aspect of the disclosed embodiments provides a method for managing pantograph arrangements on rail vehicles, the method comprising:
capturing images of a railway environment in which at least one rail vehicle operates using at least one camera, the at least one camera being arranged in the railway environment such that a pantograph arrangement of the at least one rail vehicle would lie in its field of view, and wherein the pantograph arrangement comprises a pantograph and a pantograph well;
receiving the images from the at least one camera;
processing the images to detect whether at least one of: a damage to the pantograph arrangement, presence of a foreign object in or around the pantograph arrangement, is indicated in at least one image amongst the images; and
performing at least one action when it is detected that at least one of: the damage to the pantograph arrangement, presence of the foreign object in or around the pantograph arrangement, is indicated in the at least one image.

Optionally, the step of performing the at least one action comprises:
generating an alert indicative of at least the damage to the pantograph arrangement and/or the presence of the foreign object in or around the pantograph arrangement; and
sending the alert to a device associated with an entity that manages the pantograph arrangements on the rail vehicles.

Optionally, the method further comprises determining a corrective action to be performed for remedying the damage to the pantograph arrangement and/or the presence of a foreign object in or around the pantograph arrangement, and wherein the alert is also indicative of the corrective action.

Optionally, the alert also comprises at least one of: a location of the at least one rail vehicle at a time of capturing the at least one image, the at least one image depicting the damage to the pantograph arrangement and/or the presence of the foreign object in or around the pantograph arrangement.

Optionally, the method further comprises receiving, from the device, a response from the entity with respect to the alert, wherein the response is indicative of one of: accurate detection of the damage and/or the presence of the foreign object, inaccurate detection of the damage and/or the presence of the foreign object.

Optionally, the at least one camera is arranged to capture at least one of: a top perspective view, a side perspective view, of the pantograph arrangement of the at least one rail vehicle.

Optionally, the at least one camera is arranged at a height on at least one object, wherein the at least one object is present at one or more of: along sides of a railway track on which the at least one rail vehicle operates, across the railway track on which the at least one rail vehicle operates, between two adjacent pairs of railway tracks.

Optionally, when processing the images, the method uses at least one computer vision algorithm.

Optionally, the method further comprises:
generating statistical information based on at least one of: the damage to the pantograph arrangement, the presence of the foreign object in or around the pantograph arrangement, the at least one image; and
representing, via an interactive user interface, at least one of: the statistical information, a report generated based on the statistical information.

A third aspect of the disclosed embodiments provides a computer program product for managing pantograph arrangements on rail vehicles, the computer program product comprising a non-transitory machine-readable data storage medium having stored thereon program instructions that, when executed by a processing device, cause the processing device to:
receive images of a railway environment in which at least one rail vehicle operates, from at least one camera, the at least one camera being arranged in the railway environment such that a pantograph arrangement of the at least one rail vehicle would lie in its field of view, and wherein the pantograph arrangement comprises a pantograph and a pantograph well;
process the images to detect whether at least one of: a damage to a pantograph arrangement, presence of a foreign object in or around the pantograph arrangement, is indicated in at least one image amongst the images; and
perform at least one action when it is detected that at least one of: the damage to the pantograph arrangement, presence of the foreign object in or around the pantograph arrangement, is indicated in the at least one image.

In an embodiment, the non-transitory machine-readable data storage medium can direct a machine (such as computer, other programmable data processing apparatus, or other devices) to function in a particular manner, such that the program instructions stored in the non-transitory machine-readable data storage medium case a series of steps to implement the function specified in a flowchart corresponding to the instructions. Examples of the non-transitory machine-readable data storage medium includes, but is not limited to, an electric storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Optionally, performing the at least one action comprises:
generating an alert indicative of at least the damage to the pantograph arrangement and/or the presence of the foreign object in or around the pantograph arrangement; and
sending the alert to a device associated with an entity that manages the pantograph arrangements on the rail vehicles.

Optionally, the processing device is further caused to determine a corrective action to be performed for remedying the damage to the pantograph arrangement and/or the presence of the foreign object in or around the pantograph arrangement, and wherein the alert is also indicative of the corrective action.

Optionally, the alert also comprises at least one of: a location of the at least one rail vehicle at a time of capturing the at least one image, the at least one image depicting the damage to the pantograph arrangement and/or the presence of the foreign object in or around the pantograph arrangement.

Optionally, the processing device is further caused to receive, from the device, a response from the entity with respect to the alert, wherein the response is indicative of one of: accurate detection of the damage and/or the presence of the foreign object, inaccurate detection of the damage and/or the presence of the foreign object.

Optionally, the at least one camera is arranged to capture at least one of: a top perspective view, a side perspective view, of the pantograph arrangement of the at least one rail vehicle.

Optionally, the at least one camera is arranged at a height on at least one object, wherein the at least one object is present at one or more of: along sides of a railway track on which the at least one rail vehicle operates, across the railway track on which the at least one rail vehicle operates, between two adjacent pairs of railway tracks.

Optionally, when processing the images, the processing device employs at least one computer vision algorithm.

Optionally, the processing device is further caused to:
generate statistical information based on at least one of: the damage to the pantograph arrangement, the presence of the foreign object in or around the pantograph arrangement, the at least one image; and
represent, via an interactive user interface, at least one of: the statistical information, a report generated based on the statistical information.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the disclosed embodiments may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the present disclosure will now be described, by way of example only, with reference to the following diagrams wherein:

FIG. 1 is an illustration of a block diagram of a system for managing pantograph arrangements on rail vehicles, according to an embodiment of the present disclosure;

FIG. 2 is a schematic illustration of an environment for implementing a system for managing pantograph arrangements on rail vehicles, according to an embodiment of the present disclosure;

FIG. 3 is an exemplary illustration of an image captured by at least one camera, according to an embodiment of the present disclosure;

FIG. 4 is an illustration of statistical information represented via an interactive user interface, according to different embodiments of the present disclosure; and

FIG. 5 is a flowchart illustrating steps of a method for managing pantograph arrangements on rail vehicles, according to an embodiment of the present disclosure.

### DETAILED DESCRIPTION OF THE DRAWINGS

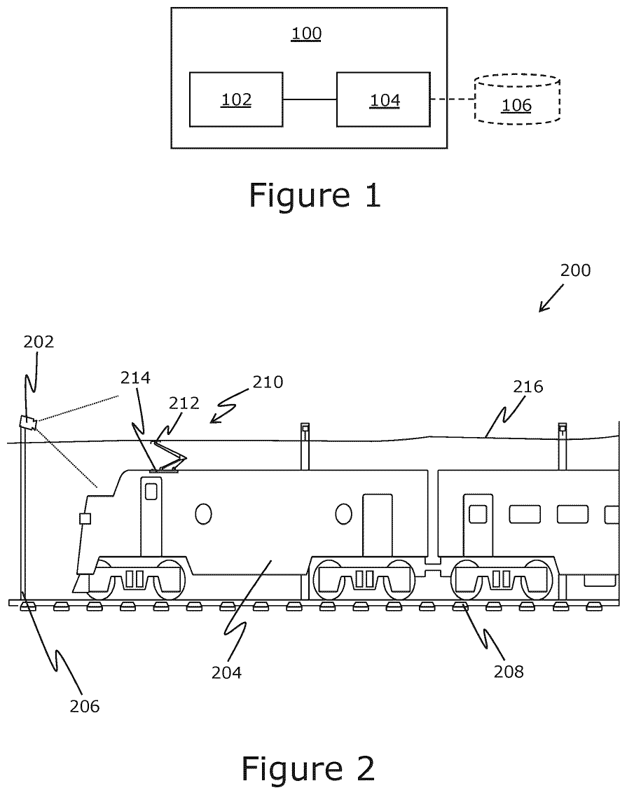

Referring to FIG. 1, there is shown an illustration of a block diagram of a system 100 for managing pantograph arrangements on rail vehicles, according to an embodiment of the present disclosure. As shown, the system 100 comprises at least one camera (implemented as a camera 102) and at least one processor (implemented as a processor 104) communicably coupled to the camera 102. The camera 102 captures images of a railway environment in which at least one rail vehicle operates. Moreover, the camera 102 is arranged in the railway environment such that a pantograph arrangement of the at least one rail vehicle would lie in its field of view. A given pantograph arrangement (not shown in FIG. 1) comprises a pantograph and a pantograph well. The processor 104 is configured to receive the images from the camera 102, and process the images to detect whether at least one of: a damage to the given pantograph arrangement, presence of a foreign object in or around the given pantograph arrangement, is indicated in at least one image amongst the images. Optionally, the system 100 further comprises a data repository 106 that is communicably coupled to the processor 104.

Referring to FIG. 2, there is shown a schematic illustration of an environment for implementing a system 200 for managing pantograph arrangements on rail vehicles, according to an embodiment of the present disclosure. As shown, the system 200 comprises at least one camera (implemented as a camera 202). The camera 202, in operation, captures images of a railway environment in which at least one rail vehicle (implemented as an electric train 204) operates. The camera 202 is arranged at a height on at least one object (implemented as a pole 206), wherein the pole 206 is present near a railway track 208 on which the electric train 204 operates. The camera 202 is arranged such that a pantograph arrangement 210 of the train 204 would lie in its field of view. Notably, the pantograph arrangement 210 comprises a pantograph 212 and a pantograph well 214. The pantograph arrangement 210 collects current from at least one overhead electrical line (implemented as an overhead line 216) for powering the electric train 204.

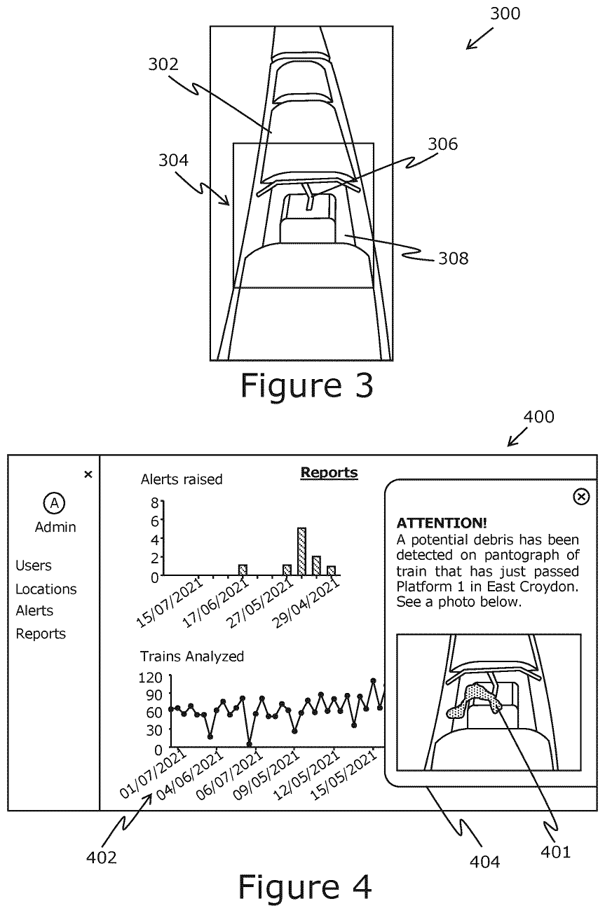

Referring to FIG. 3, there is shown an exemplary illustration of an image 300 captured by at least one camera, according to an embodiment of the present disclosure. The at least one camera is part of a system for managing pantograph arrangements on rail vehicles. The at least one camera is configured, when in operation, to capture one or more images of a railway environment in which at least one rail vehicle (implemented as an electric train 302) operates. Moreover, the at least one camera is arranged at a height in the railway environment such that a pantograph arrangement 304 of the electric train 302 would lie in its field of view. As shown, the at least one camera may be arranged to capture a top perspective view of the pantograph arrangement 304 of the electric train 302. Notably, the pantograph arrangement 304 comprises a pantograph 306 and a pantograph well 308. The image is potentially indicative of at least one of: a damage to the pantograph arrangement 304, presence of a foreign object in or around the pantograph arrangement 304. A processor (not shown) of the system processes the image to detect whether or not at least one of: the damage to the pantograph arrangement, presence of the foreign object in or around the pantograph arrangement, is indicated in the image.

Referring to FIG. 4, there is shown an illustration of statistical information 400 represented via an interactive user interface, according to different embodiments of the present disclosure. The statistical information 400 is generated based on at least one of: damage to a pantograph arrangement, presence of a foreign object 401 in or around the pantograph arrangement, at least one image. Optionally, at least one of: the statistical information 400, a report generated based on the statistical information 400, is represented via the interactive user interface. As shown, the statistical information 400 comprises at least one of: a histogram 402, an alert 404. The histogram 402 is indicative of a history of alerts raised and trains analysed on different days. The alert 404 is indicative of at least the damage to the pantograph arrangement and/or the presence of the foreign object 401 in or around the pantograph arrangement. Optionally, the alert 404 also comprises at least one of: a location of the at least one rail vehicle at a time of capturing the at least one image, the at least one image depicting the damage to the pantograph arrangement and/or the presence of the foreign object 401 in or around the pantograph arrangement. Optionally, the alert 404 is also indicative of a corrective action to be performed for remedying the damage to the pantograph arrangement and/or the presence of the foreign object 401 in or around the pantograph arrangement.

FIGS. 2, 3 and 4 are merely examples, which should not unduly limit the scope of the claims herein. A person skilled in the art will recognize many variations, alternatives, and modifications of embodiments of the present disclosure.

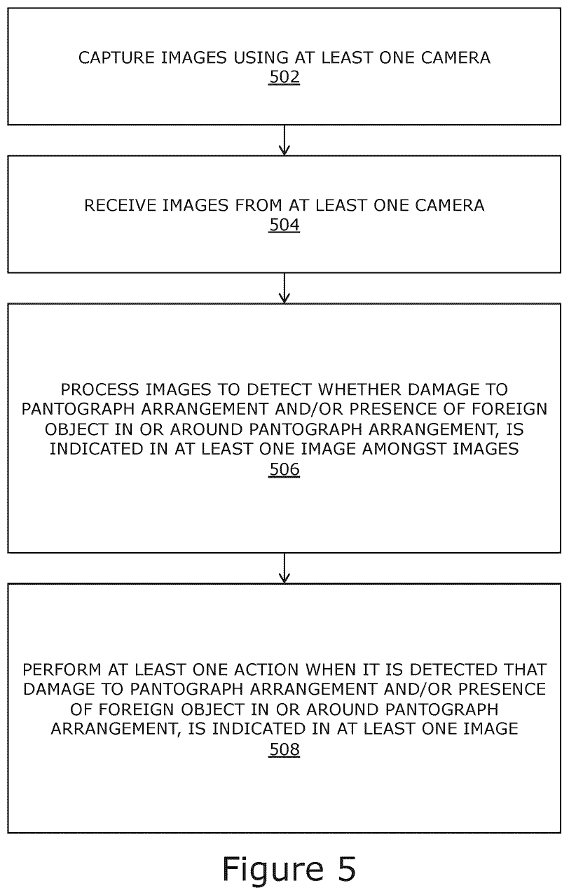

Referring to FIG. 5, illustrated is a flowchart illustrating steps of a method for managing pantograph arrangements on rail vehicles, in accordance with an embodiment of the present disclosure. At a step 502, images of a railway environment in which at least one rail vehicle operates are captured using at least one camera, the at least one camera being arranged in the railway environment such that a pantograph arrangement of the at least one rail vehicle would lie in its field of view, wherein the pantograph arrangement comprises a pantograph and a pantograph well. At a step 504, the images are received from the at least one camera. At a step 506, the images are processed to detect whether or not at least one of: a damage to the pantograph arrangement, presence of a foreign object in or around the pantograph arrangement, is indicated in at least one image amongst the images. At a step 508, at least one action is performed when it is detected that at least one of: the damage to the pantograph arrangement, presence of the foreign object in or around the pantograph arrangement, is indicated in the at least one image.

The steps 502, 504, 506 and 508 are only illustrative and other alternatives can also be provided where one or more steps are added, one or more steps are removed, or one or more steps are provided in a different sequence without departing from the scope of the claims herein.

1. A system for managing pantograph arrangements on rail vehicles, the system comprising:
at least one camera that, in operation, captures images of a railway environment in which at least one rail vehicle operates, the at least one camera being arranged in the railway environment such that a pantograph arrangement of the at least one rail vehicle would lie in its field of view;
at least one processor communicably coupled to the at least one camera, wherein the at least one processor is configured to:
receive the images from the at least one camera;
process the images to detect whether at least one of: a damage to the pantograph arrangement, presence of a foreign object in or around the pantograph arrangement, is indicated in at least one of the images, wherein the at least one processor is configured to employ at least one computer vision algorithm to process the images;
perform at least one action when it is detected that at least one of: the damage to the pantograph arrangement, presence of the foreign object in or around the pantograph arrangement, is indicated in the at least one image, wherein the at least one processor is configured to:
generate an alert indicative of at least the damage to the pantograph arrangement and/or the presence of the foreign object in or around the pantograph arrangement; and
send the alert to a device associated with an entity that manages the pantograph arrangements on the rail vehicles; and
receive, from a user device, a response from the entity with respect to the alert, wherein the response is indicative of one of: accurate detection of the damage and/or the presence of the foreign object, inaccurate detection of the damage and/or the presence of the foreign object,
wherein the at least one processor is configured to automatically update the at least one computer vision algorithm when the response is indicative of the inaccurate detection of the damage and/or the presence of the foreign object.

2. A system according to claim 1, wherein the at least one processor is further configured to determine a corrective action to be performed for remedying the damage to the pantograph arrangement and/or the presence of the foreign object in or around the pantograph arrangement, and wherein the alert is also indicative of the corrective action.

3. A system according to claim 1, wherein the alert comprises at least one of: a location of the at least one rail vehicle at a time of capturing the at least one image, the at least one image depicting the damage to the pantograph arrangement and/or the presence of the foreign object in or around the pantograph arrangement.

4. A system according claim 1, wherein the pantograph arrangement comprises a pantograph and a pantograph well.

5. A system according claim 1, wherein the at least one camera is arranged to capture at least one of: a top perspective view, a side perspective view, of the pantograph arrangement of the at least one rail vehicle.

6. A system according claim 1, wherein the at least one camera is arranged at a height on at least one object, wherein the at least one object is present at one or more of: along sides of a railway track on which the at least one rail vehicle operates, across the railway track on which the at least one rail vehicle operates, between two adjacent pairs of railway tracks.

7. A system according claim 1, wherein the at least one processor is further configured to:
generate statistical information based on at least one of: the damage to the pantograph arrangement, the presence of the foreign object in or around the pantograph arrangement, the at least one image; and
represent, via an interactive user interface, at least one of: the statistical information, a report generated based on the statistical information.

8. A method for managing pantograph arrangements on rail vehicles, the method comprising:
capturing images of a railway environment in which at least one rail vehicle operates using at least one camera, the at least one camera being arranged in the railway environment such that a pantograph arrangement of the at least one rail vehicle would lie in its field of view;
receiving, by at least one processor, the images from the at least one camera;
processing, by the at least one processor, the images to detect whether at least one of: a damage to the pantograph arrangement, presence of a foreign object in or around the pantograph arrangement, is indicated in at least one image, wherein the at least one processor employs at least one computer vision algorithm for processing the images;
performing, by the at least one processor, at least one action when it is detected that at least one of: the damage to the pantograph arrangement, presence of the foreign object in or around the pantograph arrangement, is indicated in the at least one image, wherein the step of performing the at least one action comprises:
generating an alert indicative of at least the damage to the pantograph arrangement and/or the presence of the foreign object in or around the pantograph arrangement; and
sending the alert to a device associated with an entity that manages the pantograph arrangements on the rail vehicles;
receiving, by the at least one processor, from a user device, a response from the entity with respect to the alert, wherein the response is indicative of one of: accurate detection of the damage and/or the presence of the foreign object, inaccurate detection of the damage and/or the presence of the foreign object; and
automatically updating, by the at least one processor, the at least one computer vision algorithm when the response is indicative of the inaccurate detection of the damage and/or the presence of the foreign object.

9. A method according to claim 8, wherein the method further comprises determining, by the at least one processor, a corrective action to be performed for remedying the damage to the pantograph arrangement and/or the presence of the foreign object in or around the pantograph arrangement, and wherein the alert is also indicative of the corrective action.

10. A method according to claim 8, wherein the method further comprises:
generating, by the at least one processor, statistical information based on at least one of: the damage to the pantograph arrangement, the presence of the foreign object in or around the pantograph arrangement, the at least one image; and
representing, by the at least one processor, via an interactive user interface, at least one of: the statistical information, a report generated based on the statistical information.

11. A computer program product for managing pantograph arrangements on rail vehicles, the computer program product comprising a non-transitory machine-readable data storage medium having stored thereon program instructions that, when executed by a processing device, cause the processing device to:
receive images of a railway environment in which at least one rail vehicle operates, from at least one camera, the at least one camera being arranged in the railway environment such that a pantograph arrangement of the at least one rail vehicle would lie in its field of view;
process the images to detect whether at least one of: a damage to a pantograph arrangement, presence of a foreign object in or around the pantograph arrangement, is indicated in at least one image, wherein the at least one processor is to employ at least one computer vision algorithm to process the images;
perform at least one action when it is detected that at least one of: the damage to the pantograph arrangement, presence of the foreign object in or around the pantograph arrangement, is indicated in the at least one image, wherein the at least one processor is to:
generate an alert indicative of at least the damage to the pantograph arrangement and/or the presence of the foreign object in or around the pantograph arrangement; and
send the alert to a device associated with an entity that manages the pantograph arrangements on the rail vehicles; and
receive, from a user device, a response from the entity with respect to the alert, wherein the response is indicative of one of: accurate detection of the damage and/or the presence of the foreign object, inaccurate detection of the damage and/or the presence of the foreign object,
wherein the at least one processor is to automatically update the at least one computer vision algorithm when the response is indicative of the inaccurate detection of the damage and/or the presence of the foreign object.
